(19) United States
(12) Patent Application Publication
(10) Pub. No.: US 2012/0252687 A1
(43) Pub. Date: Oct. 4, 2012

(54) Scoring Function Penalizing Compounds Which Desolvate Charged Protein Side Chains Structure

(76) Inventors: Richard A. Friesner, New York, NY (US); Robert Murphy, Englewood Cliffs, NJ (US)

(21) Appl. No.: 13/079,489

(22) Filed: Apr. 4, 2011

(51) Int. Cl. C40B 30/04

(52) U.S. Cl. 506/9

(57) ABSTRACT

A method of scoring binding affinity of a proposed ligand molecule for a receptor molecule using a computer and computer data bases, which accounts for the increase in energy required where docking disrupts water molecules that are localized or localized. The method uses computer-stored data representing a predicted ligand-receptor structure (preferably one that is validated) as well as computer-stored data representing a library of compounds to be tested. Data representing members of the compound library is analyzed by computerized operations which determine whether the receptor in the predicted ligand-receptor structure includes a) determining whether the receptor in the predicted ligand-receptor structure includes solvating water molecule(s) whose desolvation into the surrounding environment requires substantial energy, b) determining whether a docking configuration for a member of the compound library with the receptor requires desolvation of one or more of the desolvating water molecule(s), and, if so, assigning a desolvation penalty to the member of the compound library.

### TECHNICAL FIELD

The invention is in the general field of computer-based methods for estimating binding affinity between a ligand and a receptor molecule.

### RELATED CASES

Simultaneously with the filing of this patent application we are filing a commonly owned patent applications entitled “Binding Affinity Scoring Function Penalizing Compounds which Make Unfavorable Hydrophobic Contacts With Localized Water Molecules in the Receptor Active Site”, which is hereby incorporated by reference in its entirety.

### BACKGROUND

Many drugs operate by chemically binding to specific molecular receptors. Molecular receptors typically are specific proteins (a term that includes glycoproteins and lipoproteins) in an animal such as a human being, and drug design and selection can be facilitated by accurately estimating the binding affinity of a drug to a protein, or, more generally, estimating the binding affinity of a ligand to a receptor, the term receptor being used to mean any moiety that specifically binds the ligand.

One way to determine receptor-ligand binding affinity uses the molecular structure that results when the ligand binds to the receptor (“the ligand-receptor complex”). Such structures may be studied by x-ray crystallography. The publicly accessible protein data bank (PDB) now contains more than 70,000 x-ray crystal structures, and pharmaceutical and biotechnology companies have an order of magnitude more proprietary structures. Many of these structures have been co-crystallized with small molecules bound to them. The examination of such structures, and deployment of the knowledge thereby gained to design new, more potent, and more specific inhibitors, is referred to as structure-based drug design.

Computational modeling facilitates structure-based drug design. One aspect of modeling detailed below involves scoring functions that use simulation techniques, such as molecular dynamics, Monte Carlo, or continuum electrostatics calculations. Scoring functions can be problematic when one is required to calculate a very small difference (the binding affinity) between two very large numbers (the free energies of the complex and of the separated protein and ligand). An alternative approach is to develop an empirical scoring function, based on the geometry of the complex, which directly evaluates the desired quantity. Such an approach has the advantage of being extremely fast as well as being amenable to fitting to experimental data, large amounts of which are now publicly available. Commonly owned US 2007/0061118 A1 (hereby incorporated by reference), which is hereby incorporated by reference in its entirety, discloses such scoring functions.

It is desirable to increase the accuracy and robustness of scoring functions by making material improvements in the functional form that better reflect physical reality. Commonly owned PCT application WO/2008/141260 (hereby incorporated by reference) describes improvements intended to improve rank ordering of the binding affinities of a series of ligands bound to a specified receptor.

A second major problem with scoring functions is that they may assign better (more negative) binding affinity scores to inactive compounds (i.e. compounds that would not be determined to bind to the receptor in a typical experimental screening protocol) than to active compounds. If a large number of inactive compounds are ranked ahead of active compounds, a principal function of docking, which is to discover new active compounds against a specified receptor from a very large compound library (often millions of compounds), becomes difficult to carry out effectively. Therefore, substantially reducing the number of “false positives” (ranking of inactive compounds as active) would greatly improve scoring function performance.

### SUMMARY

We have discovered a method of scoring binding affinity of a proposed ligand molecule for a receptor molecule using a computer and computer data bases, which accounts for the increase in energy required where docking disrupts water molecules that are localized. We include in the term “localized water” waters that are localized or quasi-localized, i.e., any water occupying a hydration site where the local water occupancy density at the hydration site is substantially higher than the number density of bulk fluid. The presence of such localized water at hydration sites can be determined by running and analyzing a molecular dynamics trajectory, or from experimental data such as water densities obtained from x-ray crystallographic experiments. Localized water sites may be identified by active-site solvation analysis such as the WaterMap analysis for assigning displacement free energies described below or by other analyses also described below.

The method uses computer-stored data representing a predicted ligand-receptor structure (preferably one that is validated) as well as computer-stored data representing a library of compounds to be tested. Typically we use the rigid-receptor approximation so we mean to include data representing the receptor alone (with the ligand removed) when we refer to “data ligand-receptor structure”. Data representing members of the compound library is analyzed by computerized operations which determine whether the receptor in the predicted ligand-receptor structure includes: a) determining whether the receptor in the predicted ligand-receptor structure includes localized solvating water molecule(s) proximate to a formally charged group of the receptor, whose desolvation into the surrounding environment requires substantial energy, b) determining whether the configuration of the receptor-ligand complex requires desolvation of one or more of the localized solvating water molecule(s) referred to above in (a), and, if so, and, if so, c) assigning a desolvation penalty to be added to the binding affinity score of the ligand.

In preferred embodiments of the invention, the receptor is a protein and the solvating water molecules form hydrogen bonds with a charged atom in the side chain of one or more Asp, Glu, Arg, or Lys residues in the receptor. The scoring includes various exceptions to assessing the penalty if the computer determine that: a) an atom in the residue side chain is part of a salt bridge with an oppositely charged receptor atom a distance less than 3.5 Å from the side chain atom; b) a formally charged atom in the protein is within 3.0 Å of a metal atom; c) a charged atom of the amino acid that residue that includes the side chain atom is in a salt bridge; d) a charged atom of the amino acid that residue that includes the side chain atom is hydrogen bonded to other atoms in the receptor; e) the side chain atom is in a salt bridge with the library compound; f) a positively charged protein atom has close contacts with at least three aromatic protein side chains; g) the side chain atom has two or more nearby unsalted protein atoms of opposite charge which provide a net charge surrounding the side chain atom; h) the side chain atom is hydrogen bonded to a neutral ligand atom; i) the side chain atom includes a localized (e.g., WaterMap) water of 0.7 displacement score or more within at least 3.8 Å; j) the angular distribution of whether localized waters and receptor atoms surround the charged side chain receptor atom, preventing access to ambient water molecules; k) the charged side chain receptor atom is surrounded and the method comprises calculating angular distribution of localized waters and receptor atoms, and determining whether those localized and receptor atoms are within 6 Å of the charged side chain receptor atom; l) one or more of the following conditions obtains: I) the charged side chain receptor atom does not contact a hydrogen atom; II) a ligand atom is within 4 Å of the charged side chain receptor atom and the ligand atom; III) the charged side chain receptor atom is negatively charged and the ligand atom is hydrogen bound to a charged receptor atom; IV) the ligand atom is part of a ring with is salt-bridged to the receptor; V) the charged side chain receptor atom is positively charged and the ligand atom is N or O or a carbon atom directly attached to N or O. Also preferably in the latter case, a penalty is assessed only if the charged side chain receptor atom has two or more ligand atom interactions that are characterized by one or more of conditions a.-d. Penalty assessment in a given case is performed via an empirical analysis, where the specific penalties assigned to particular set of interactions of the ligand with localized water molecules at the receptor hydration sites are effectively precomputed and reapplied. Further, such a penalty assessment requires only a single configuration of the receptor-ligand complex, and is significantly faster (<½ hour) than alternative pure physics-based approaches that describe such penalties implicitly by attempting to fully describe the whole range of physics manifest by the ligand or the ligand-receptor complex ensemble.

Other features and advantages of the invention are apparent from the following description, and from the claims.

### DESCRIPTION OF DRAWINGS

The file of this patent contains at least one drawing executed in color. Copies of this patent with color drawings will be provided by the Patent and Trademark Office upon request and payment of the necessary fee.

FIG. 1. Decoy molecule 352249 is here depicted to desolvate water molecules 17 and 68 from the lysine 67 ammonium group. This results in a 4.0 kcal/mol desolvation penalty brining the predicted binding affinity of the decoy molecule in better agreement with the binding affinities one would expect of such molecules from an experimental random screen of such molecules.

FIG. 2. Active ligand 3bgp is here depicted to desolvate water molecules 17 and 68 from the lysine 67 ammonium group. However, in contrast to the decoy molecule depicted in FIG. 1, no penalty term is applied since the active molecule forms a hydrogen bond with the lysine 67 ammonium subsequent to desolvating the group.

FIG. 3. Active ligand 2o0u is here depicted to desolvate water molecule 31 from the ammonium group of lysine 93. This results in a 4.0 kcal/mol desolvation penalty brining the predicted binding affinity of the active molecule in better agreement with the experimental measurement.

### DETAILED DESCRIPTION

Practicing the invention begins with a receptor (or “target”, typically a protein) structure that has sufficient resolution to permit the use of computational software to “dock” a small molecule ligand into the correct position and orient it in the receptor active site cavity and to calculate a binding affinity of the ligand given this structure. Computer software programs that perform this task are referred to as “docking” programs.

A docking program typically carries out two distinct tasks to model receptor-ligand binding. First, a structure of a receptor-ligand complex is predicted by docking the ligand into the receptor structure. When this protocol fails to produce an accurate structure of the protein-ligand complex, use of a different structure of the receptor as a starting point is required. The problem of constructing alternative receptor structures that are modified to accept ligands requiring a substantial change in receptor conformation (“induced fit”) is a very important one.

Various adequate receptor-ligand structure prediction programs are well known and can be used for the starting point, and those in the art will understand that no particular methodology is critical. Examples of such functions that are readily available include: Glide, GOLD, FRED, FlexX, or AutoDock, among many others. Once in possession of a receptor structure in reasonable agreement with experimental data, the second task of the docking program is to calculate a receptor-ligand binding affinity, given as an input the docked structure. A mathematical function employed to calculate the binding affinity (or a contribution thereto) is referred to as a “scoring function.” Improvements to such scoring functions for calculating receptor-ligand binding affinity are the subject of this invention.

The estimates of receptor-ligand binding affinities described below are applicable when a structure of the receptor-ligand complex is represented by a suitable structural model. There are a number of ways to characterize the quality of structural models of receptor-ligand complexes, so long as the model adequately agrees with experimental data. Measures of structural agreement such as RMSD, DME, or SIFt score among others might be used. Accurate scores are typically but not exclusively obtained using: i) a small root mean square deviation (RMSD) from the experimental structure (typically less than 2 Angstroms, although the required value will vary depending upon details of the complex), ii) recognition of the formation of substantially all hydrogen bonds seen in the experimental complex, iii) appropriate placement of substantially all hydrophobic groups in the correct receptor cavities, and iv) the absence of incorrect structural or electrostatic clashes that could lead to the assignment of substantially incorrect penalty terms. Since relative binding affinity of ligands to a given receptor is under consideration, a constant offset, as is in many cases engendered by reorganization energy of the receptor active site to accommodate the ligand, has no effect on practical applications.

In many (although not all) cases, the receptor can adopt more than one fundamentally different conformation in response to a class of ligands (e.g., DFG-in and DFG-out binders to p38 map kinase); to compare the binding free energies in such cases, different core reorganization parameters may be required for the different receptor conformations. Where calculation of these parameters is not practical from first principles they are treated as adjustable, receptor-specific parameters. Other parameters are however contained in a global model which is not receptor-specific or even specific to a particular class of receptors.

The present invention is focused on improving the ability of the scoring function to discriminate inactive and active compounds against a given receptor. While active compounds for a wide range of receptors are readily found in the Protein Data Bank (PDB), our data below validating the invention required also assessed known inactive compounds or an approximate, but sufficiently accurate, model for a library of such compounds. Accessing known inactive compounds from publicly available data is challenging. Therefore, we have devised an alternative protocol, to represent an approximate but sufficiently accurate model of a library of inactive compounds, which is based on the use of a random library of 1000 drug-like compounds. These compounds are docked into a conformation of the receptor, and predicted binding affinities are obtained for each compound using various proposed improvements to the scoring function.

Our scoring function is calibrated so that active compounds achieve scores that are typically close to experimental binding affinities, with a standard deviation of approximately 1 log unit of binding affinity (˜1.5 kcal/mole). An experimental “hit” in a random screen in the pharmaceutical industry is generally taken to have a binding affinity of ˜7.0 kcal/mole or more (˜10 μm concentration). Given the intrinsic fluctuations in the scoring function of 1.5-2.0 kcal/mole, we set the computational threshold for estimating hits at a score of −9.0 kcal/mole; thus any compound in the random 1000 compound library which scores −9.0 or less is predicted to be a hit. Other compounds in the −7.0 to −9.0 range are predicted as possible hits as well, but such scores may also be due to the noise in the scoring function which we are unable at present to reduce further (in part due to limitations on the publicly available experimental data). Hence, we focus in developing our improvements on ensuring that the number of random compounds scoring more negatively than −9.0 is compatible with experimental hit rates for random drug-like compound libraries

The hit rate for experimental screens will vary depending upon the receptor, but an illustrative “average” hit rate is 0.5%, or 5 compounds out of 1000. Thus, if substantially more than 5 compounds achieve a score of −9.0 kcal/mole, the assumption is made that inactive compounds are receiving scores that are too favorable. In general, reduction of the number of random library compounds scoring more negatively than −9.0 is taken as improvement of the scoring function, as in the absence of fluctuations, one would expect even fewer (0-2) compounds in this range.

In such a situation, the scoring function may be improved by adding positive “penalty” terms which reduce the magnitude of the predicted binding affinity. Such terms represent physical processes which make binding less favorable. An example of a process of this type would be a desolvation in which a polar group of the protein or ligand is blocked by nonpolar groups of the ligand and loses access to water. This results in a large loss in free energy, making the compound inactive. If the loss of free energy is sufficiently large, then such penalties will only rarely (if at all) be observed in complexes with active compounds. This means that the new terms must be derived by examining the structures produced when the random library is docked into the receptor.

The invention described in this application utilizes a description of localized or localized water structure in the receptor active site. One but by no means the only way to do so is to use technology designated “WaterMap” (U.S. Pat. No. 7,756,674, hereby incorporated by reference). WaterMap uses molecular dynamics simulations to place waters at various locations in the active site, and assigns estimated enthalpies and entropies that would be obtained if the water were displaced to bulk solvent by the ligand. The enthalpies and entropies are estimated via a modified version of inhomogeneous solvation theory. Other techniques could be used to place localized waters and estimate their entropies and enthalpies. The invention can be applied as long as the locations of localized waters are specified. The displacement free energies may lead to better accuracy, but significant benefit of the invention can be obtained as long as localized water positions can be enumerated. Such positions can be derived not only from computational methods but also from experimental data, such as x-ray crystallography. Crystallography determines some localized water positions, but not others (typically depending upon the degree of localization). This invention is intended to apply regardless of how the localized water distribution is determined. Other ways to establish the existence of localized water might include appropriate analysis of explicitly solvated Monte Carlo simulations, applications of RISM-type theories, or NMR experiments among other techniques.

The penalty term comprising this invention is intended to penalize desolvation of a charge side chain (aspartic acid, glutamic acid, arginine, or lysine) if one or more charged atoms of the side chain are surrounded by localized waters. It is important to recognize that, when a localized water structure forms around a charged group, disruption of that structure by the ligand without forming a hydrogen bond prevents effective solvation, and therefore makes the overall free energy significantly more unfavorable. Such disruption should be contrasted to placing (for example) a hydrophobic ligand group near a charged group when the water structure around the ligand is close to that of bulk water. In this case, the water can typically reorganize itself to effectively solvate the charged group despite the intrusion of the hydrophobic ligand group. When the water structure is localized, such reorganization will cost substantial free energy, because the localization is an effective indication of substantial additional constraints on the water structure engendered by the protein cavity.

The invention includes conditions which determine when to apply a penalty term. One way to do that is to use algorithm(s) which instruct a computer.

Those in the art will recognize that many different algorithms can be used. We have developed one particular algorithm based on a combination of the basic physical chemistry principles, outlined above, and empirical optimization in which we have designed the algorithm to avoid inappropriately penalizing (i.e. applying a penalty that would make the score of the compound agree less well with experimental binding affinity data than if the penalty were not applied) known complexes of active compounds, taken from the protein data bank (PDB), while at the same time maximizing the number of favorably scoring random data base compounds that are penalized. Details of the optimization protocol are outlined below, after a description of the algorithm itself.

1. Formally charged protein heavy atoms of charged residues are considered for a desolvation penalty if they satisfy the following set of filters:
a) The protein atom is not in a salt bridge with an oppositely charged protein atom closer than 3.5 Å away nor is another charged atom of the same residue in a salt bridge.
b) A formally negatively charged protein atom is not within 3 A of a metal atom.
c) A positively charged protein atom does not have three or more close contacts with an aromatic protein residue (this is a crude measure of a pi-cation interaction, which can replace aqueous solvation).
d) The protein atom is not in a salt bridge with the ligand; except that, if the protein atom has two or more nearby unsalted protein atoms of opposite charge such that there is a net charge surrounding the protein atom, the protein atom qualifies for a potential penalty notwithstanding the salt bridge.
e) The protein atom is not hydrogen bonded to a neutral ligand atom.
f) No other charged atom of the residue containing the protein atom is in a salt bridge.
g) The protein atom nor charged atoms of the same residue as the protein atom is hydrogen bonded to other protein atoms.
h) There must be a localized water within 3.8 Å of the charged protein atom which has a removal fraction of 0.7 or more (see our U.S. patent application entitled “Binding Affinity Scoring Function Penalizing Compounds which Make Unfavorable Hydrophobic Contacts With Localized Water Molecules in the Receptor Active Site”, filed concurrently with this application and hereby incorporated by reference in its entirety).
a) The removal fraction (or synonymously the displacement score) is computed as follows
   a. for each WaterMap water calculate a fractional number representing the extent to which the water is displaced by contacts with ligand heavy (non-hydrogen) atoms. The displacement fraction is calculated as follows;

a) for each ligand atom i calculate the distance d to the WaterMap water.

b) calculate the sum r the ligand Vdw radius rᵢ and a fixed water Vdw radius of 2.2 Å, r=R_i+2.2.

c) If d<r then the contribution vac_i that ligand atom i makes to the evacuation of water i is

vac_{—}i=1.0−d/r r<=d, vac_{—}i=0.0 r>d.

d) the total fraction that water i is removed is the sum over such v_i with the sum limited a maximum of 1.0.

2. For charged protein atoms that pass the filters 1a-h calculate two more filters 2a, 2b:
a) Calculate a measure of the angular distribution of nearby quasilocalized (e.g., WaterMap) waters and protein atoms surrounding the charged protein atom (near neighbor list). The angular distribution of nearby quasilocalized (e.g., WaterMap) waters and protein atoms surrounding the charged protein atom is computationally described through following procedure. The surrounding protein atoms or waters are checked to be within 6 Å of the charged protein atom. The charge protein atom must be surrounded in a three dimensional sense by protein and water atoms to qualify. The angular distribution is then computed as follows;
   a1) For each element i in the near neighbor list calculate the vector connecting the element i and the protein atom, v_i. Given this vector loop on all other elements of the neighbor list calculating the vector v_j connecting the protein to the element (note the opposite direction to the first vector). Thirdly calculate the angle between v_i and v_j. Store the minimum angle between v_i and all v_{j}, call it v_i_min. Finally calculate the average of v_i_min.

Ave_coverage=Sum_{—}{i} min(Sum_{—}{j} Anlge(v_{—}i<−>v_{—}j)/(total elements {i}).

In the limit of spherical coverage this ave_coverage number is zero since for every vector connecting the charged protein atom to an element, the opposite of this vector points at another element. The ave_coverage number must be below 25.0 for the charged protein atom to qualify for a penalty. Thus, the computed “Ave_coverage” quantity is a compact description of the angular distribution of nearby localized (e.g., WaterMap) waters and protein atoms surrounding the charged protein atom.
b) calculate the number of second shell localized waters around the charged protein atom. This number is the total number of such waters which are c1) more than 5 A from the charged protein atom, and c2) within 3.8 Å of another localized water which is within 3.8 Å of the charged protein atom (first shell water map water). Second shell waters must have a removal fraction of no more than 0.3 (see 3 of water-ligand contact writeup for definition of removal fraction). Negatively charged protein atoms must have at least 3 second shell localized (e.g. WaterMap) waters to qualify for a penalty.

3. If the charged protein atom satisfies filters 1a-h, and 2a, 2b then check for contacts between this protein atom and ligand atoms as follows:
a) The ligand atom must not be a hydrogen atom.
b) The ligand atom is within 4 Å of charged protein atom.
c) If the protein atom is negatively charged and the ligand atom is an aromatic carbon oriented toward the oxygen in (CH═O), then the contact is not counted. Similarly the contact is not counted if the ligand atom is within a 1-2 connection table distance of another ligand atom aromatically bound to the charged protein atom.
d) If the ligand atom is hydrogen bound to any charged protein atom the contact is not counted.
e) If the ligand atom is part of a ligand ring which is salted bridged to the protein then the ligand contact is not counted.
f) If the charged protein atom is positively charged and the ligand atom is N or O, the contact to the ligand atom is skipped. Similarly the contact is skipped for ligand carbon atoms attached to N/O ligand atoms.

4) If the charged protein atom has two or more contacts with the ligand that pass the filters above then a penalty of 4 kcal/mole is assigned for desolvating the charged protein atom.

The efficacy of the above invention is demonstrated in the following fashion. Firstly, we have assembled a test suite of 622 protein-ligand complexes of active compounds. As a control for evaluating the method, the examples below involve known crystal structures available in the Research Collaborative for Structural Bioinformatics' publicly accessible Protein Data Bank (“the PDB”). In carrying out optimization, we use poses docked with Glide XP™, a scoring function described e.g., in US 2007/0061118 A1 (hereby incorporated by reference in its entirety), filtering the very small number of cases for which self-docking yields unsuitable structures. Because our optimization process uses docked structures, rather than the crystal structures, we increase the realism of the model, and also enable the docking to correct small geometrical errors in the crystal structures (e.g. in hydrogen bond distances) which can be important for properly assigning scores to these terms. The invention does not require the use of ligands for which crystal structures are known, nor does it require the use of Glide XP™.

The PDB structures can be viewed as a large and diverse training set for the scoring function. Testing of the scoring function under similar conditions can be performed by pharmaceutical and biotechnology companies, using proprietary data sets where crystal structures are available. In carrying out these tests, there is no need to release the structures or even to divulge the name of the receptor; one can simply perform the calculations, and report the ability to rank order the compounds as a correlation coefficient.

These complexes give reasonably accurate structures when the ligand is redocked into its native receptor (maximum RMSD is 3.5 Å, and the great majority are below 2.0 Å) and their scores, using the most recent version of the Glide XP™ scoring function, are on average within ˜1 kcal/mole of the experimental binding affinity. Thus, the scoring function in the absence of the term constituting the invention works well for complexes of active compounds taken from the PDB.

We have added the new term to the Glide XP™ scoring function and rerun the active calculations with it in place. In Table I, there is a list of PDB complexes which are impacted by this term, the experimental binding affinity of each complex, and the calculated binding affinity with and without the new term. It can be seen that there are very few cases where active complexes satisfy the above conditions, but when they do, the applied penalty actually significantly improves agreement between theory and experiment or at the very least does not make the results worse. These results demonstrate that the invention as described is not generally a characteristic of complexes of receptors with active complexes.

The second criterion for efficacy of the invention is penalizing random database ligands which are assigned highly favorable scores by the current scoring function. In a 1000 compound random database, it is very unlikely that experimentally one would find a compound with a binding affinity that was tighter than 500 nm, or −9 kcal/mole. Therefore a penalty term is improving discriminatory power when it eliminates compounds with binding affinities as good or better than −9 kcal/mole without inappropriately penalizing any active compounds. Because of the intrinsic fluctuations in the scoring function of 1.5-2 kcal/mole, noted above, we nevertheless expect to see some compounds scoring at the −9.0 kcal/mole level (or a little better); these represent active compounds that experimentally would have binding affinities in the −7.0 to −9.0 kcal/mole range, but which achieve a better score due to the scoring function fluctuations. However, if the experimental hit rate for a 10 micromolar screen is on the order of 0.5% (typical for pharmaceutically interesting targets, although there can be significant deviations in either direction from this value), then one would expect there to be no more than 5 compounds from the random library scoring below −9.0 kcal/mole. Hence, the success in reducing the number of such values for the suite of receptors tested below 5, and in general reducing the number as much as possible, is a good measure of the efficacy of the penalty term.

Table 2 displays the number of ligands from our standard 1000 compound random library of drug like molecules whose scores are less than −9 kcal/mole for several different scoring functions and for 24 test receptors. This specific comparison is meaningful only if the scores for active compounds are close to the experimental scores for these compounds, so in the first column of Table 2 we present results obtained with a version of Glide XP™ which has been optimized to reproduce the scores of PDB complexes with an average error of ˜1 kcal/mole. Penalty terms, such as the current invention, must then be added to this scoring function to improve performance in discriminating active from inactive compounds.

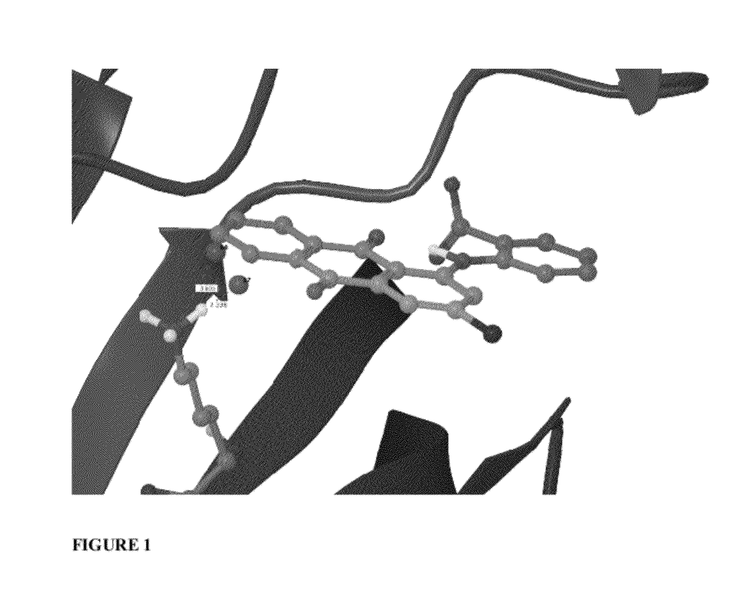

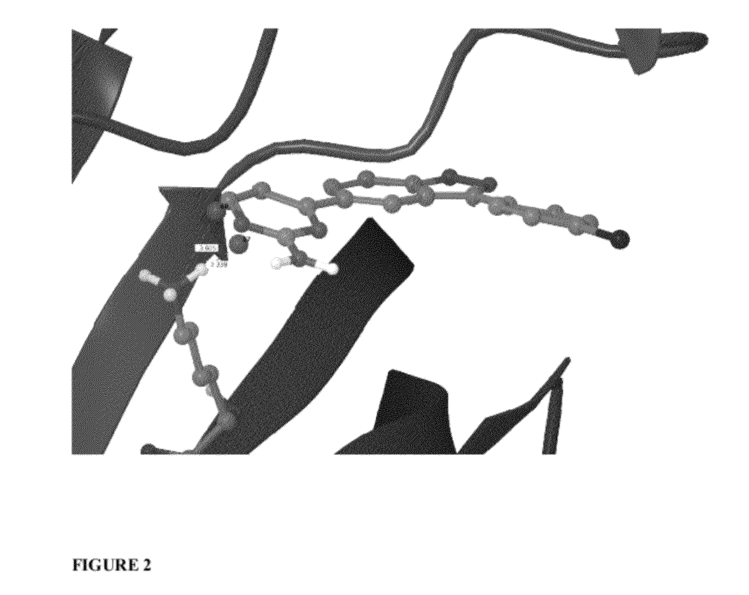

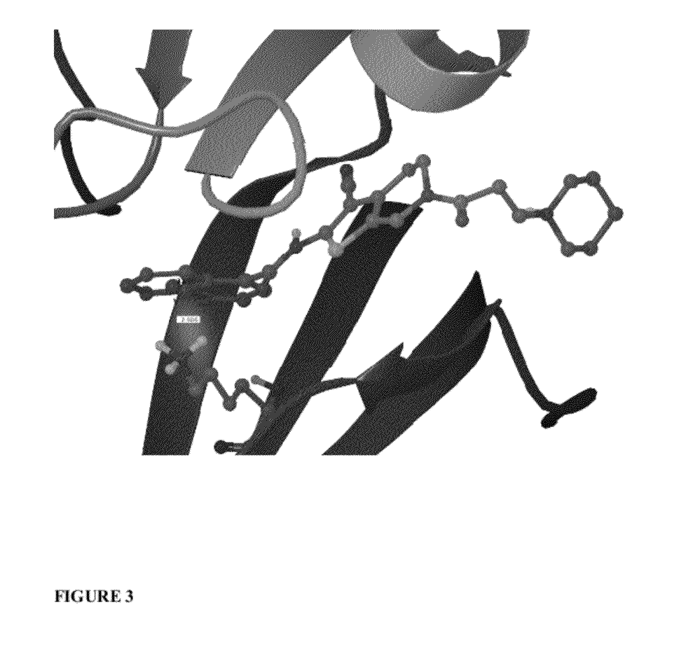

In the second column, we present results obtained when all of our recently developed novel penalty terms, including the present invention, are included in the scoring function. This results in a significant reduction in the number of decoys that score −9 kcal/mole and lower. Finally, to isolate the specific performance of the invention described herein, column three present results of adding the invented term to the scoring function of column 1. The present invention is illustrated by the PIM receptor but not the other receptors shown in the table, because the situation identified by the invention is rather unusual. For the PIM case, the effect of the invention is very substantial, reducing the score of a large number of high scoring decoys. This result indicates that when charged groups are solvated by localized waters, the invention will be a very important filter in separating active compounds from inactive compounds. As every drug target is potentially of substantial importance from a biomedical point of view, an invention that significantly impacts 5% of drug targets has substantial utility and it would give organizations working on those drug targets a significant competitive advantage. Finally, in column 4, we present results of deleting the invention from the overall best practices scoring function presented in column 3. This data demonstrates that the invention is an important component of the overall best practices method; without it, performance is degraded for the two cases we have indicated above. For PIM, for example, the number of database ligands with scores below −9.0 kcal/mole is 27 (clearly much too large a hit rate) when the invention is deleted, but when the invention is added back into the scoring function, only 3 database ligands (a reasonable hit rate as outlined above) such decoys remain. Examples of the application of the penalty term are also depicted in FIGS. 1 through 3.

Taken together, the above data demonstrates unambiguously that the invention described herein make a substantial contribution to discriminating active from inactive compounds in the Glide XP™ empirical scoring function. Similar improvement would be seen in any score function which itself was lacking in a comparable penalty term; to our knowledge, existing published scoring functions do not contain such a term at present.

TABLE 1
Two native pdb ligands affected by the blocked residue term,
score_np is the unrealized score and score_p the penalized
score, dG is is the experimental free energy of binding.

| Pdb_system | Score_np | Score_p | dG |
|---|---|---|---|
| Jnk_2o0u | −11.5 | −7.5 | −7.5 |
| Cdk2_1ykr | −10.6 | −6.6 | −8.5 |

TABLE 2
Number of decoy ligands with scores less than −9 kcal/m for
a version of XP without recently developed penalty terms (XP),
XP with the newer penalty terms (new XP) and XP with the addition of
the charged residue term of this patent (XP_res).

| Pdb_system | XP_{—} | newXP | XP_res | newXP_nores |
|---|---|---|---|---|
| Abl | 24 | 15 | 24 | 15 |
| Alr2 | 18 | 4 | 18 | 4 |
| Jnk | 7 | 2 | 7 | 2 |
| Aur | 2 | 2 | 2 | 2 |
| Cdk2 | 10 | 3 | 10 | 3 |
| Chk1 | 7 | 4 | 7 | 4 |
| Dpp4 | 7 | 1 | 7 | 1 |
| Er | 4 | 0 | 4 | 0 |
| Erk2 | 0 | 0 | 0 | 0 |
| Err | 3 | 2 | 3 | 2 |
| Fviia | 2 | 0 | 2 | 0 |
| Fxa | 0 | 0 | 0 | 0 |
| Hivrt | 11 | 2 | 11 | 2 |
| Hsp90 | 2 | 0 | 2 | 0 |
| Lck | 10 | 3 | 10 | 3 |
| Oppa | 1 | 1 | 1 | 1 |
| Pim1 | 46 | 3 | 7 | 27 |
| Pka | 0 | 0 | 0 | 0 |
| Ppar | 1 | 0 | 0 | 0 |
| Ptp1b | 1 | 1 | 1 | 1 |
| Rho | 5 | 2 | 5 | 2 |
| Throm | 2 | 1 | 2 | 1 |
| Upa | 0 | 0 | 0 | 0 |
| P38 | 0 | 0 | 0 | 0 |

Column four has new_xp without the charged residue term (new_XP_nores)

Other embodiments are within the scope of the following claims. Note that the above penalties values are only representative. Typically for physically reasonable ligands the total penalty assessed under this invention will be less than 5 kcal/mole.

What is claimed is:

1. A method of scoring binding affinity of a proposed ligand molecule for a receptor molecule using a computer and computer data bases, the method comprises,
a) obtaining computer stored data representing a predicted ligand-receptor structure,
b) assigning a penalty to be added to the binding affinity score by computerized operations which includes the following steps:
i. determine whether the receptor in the predicted ligand-receptor structure includes localized solvating water molecule(s) proximate to a formally charged group of the receptor, whose desolvation into the surrounding environment requires substantial energy,
ii. determine whether the configuration of the receptor-ligand complex requires desolvation of one or more of the localized solvating water molecule(s) referred to above in (i), and, if so,
iii. assign a desolvation penalty to be added to the binding affinity score of the ligand.

2. The method of claim 1 in which the receptor is a protein and the solvating water molecules form hydrogen bonds with a charged atom in the side chain of one or more Asp, Glu, Arg, or Lys residues in the receptor.

3. The method of claim 2 in which the scoring includes determining whether an atom in the residue side chain is part of a salt bridge with an oppositely charged receptor atom a distance less than 3.5 Å from the side chain atom, and, if so, the penalty is not assessed.

4. The method of claim 2 in which the scoring includes determining whether a formally charged atom in the protein is within 3.0 Å of a metal atom; if so the penalty is not assessed.

5. The method of claim 2 in which the scoring includes determining whether a charged atom of the amino acid that residue that includes the side chain atom is in a salt bridge; if so the penalty is not assessed.

6. The method of claim 2 in which the scoring includes determining whether a charged atom of the amino acid that residue that includes the side chain atom is hydrogen bonded to other atoms in the receptor; if so, the penalty is not assessed.

7. The method of claim 2 in which the scoring includes determining whether the side chain atom is in a salt bridge with the library compound; if so the penalty is not assessed.

8. The method of claim 2 in which the scoring includes determining whether a positively charged protein atom has close contacts with at least three aromatic protein side chains; if so the penalty is not assessed using this charged protein atom as the starting point for the penalty calculations described by the invention.

9. The method of claim 2 in which the scoring includes determining whether the side chain atom has two or more nearby unsalted protein atoms of opposite charge which provide a net charge surrounding the side chain atom; if so the penalty is not assessed.

10. The method of claim 2 in which the scoring includes determining whether the side chain atom is hydrogen bonded to a neutral ligand atom; if so the penalty is not assessed.

11. The method of claim 2 in which the scoring includes determining whether a localized water within a distance of 3.8 Å of a side chain charged atom or less achieves a displacement score of at least 0.7 by the ligand, i.e. is defined as displaced into bulk solution by the ligand; if not the penalty is not assessed.

12. The method of claim 1 in which the scoring includes determining whether the angular distribution of localized waters and receptor atoms surround the charged side chain receptor atom, preventing access to bulk-like water molecules; if not no penalty is assessed.

13. The method of claim 12 in which the determination of whether the charged side chain receptor atom is surrounded comprises calculating the angular distribution of localized waters and receptor atoms, where only water molecules and receptor atoms within 6 A of the charged side chain receptor atom are considered in assessing whether the atom is surrounded.

14. The method of claim 1 in which the scoring includes determining whether one or more of the following conditions obtains:
a. the charged side chain receptor atom does not contact a hydrogen atom;
b. a ligand atom is within 4 Å of the charged side chain receptor atom and the ligand atom;
c. the charged side chain receptor atom is negatively charged and the ligand atom is,
i. hydrogen bound to a charged receptor atom;
ii. the ligand atom is part of a ring with is salt-bridged to the receptor
d. the charged side chain receptor atom is positively charged and the ligand atom is N or O or a carbon atom directly attached to N or O;
each of said conditions resulting in no penalty assessment.

15. The method of claim 14 in which a penalty is assessed only if the charged side chain receptor atom has two or more ligand atom interactions that are characterized by one or more of paragraphs a.-d.
